(19) United States
(12) Patent Application Publication
(10) Pub. No.: US 2026/0307307 A1
(43) Pub. Date: Oct. 8, 2026

(54) REINFORCED PANEL AND METHOD OF MANUFACTURE

(71) Applicant: Gemini Group, Inc., Bad Axe, MI (US)

(72) Inventor: Mark Robinson, Bad Axe, MI (US)

(73) Assignee: Gemini Group, Inc., Bad Axe, MI (US)

(21) Appl. No.: 19/557,799

(22) Filed: Mar. 5, 2026

Related U.S. Application Data
(60) Provisional application No. 63/782,416, filed on Apr. 2, 2025.

(51) Int. Cl. B29C 45/14; B29L 31/30

(52) U.S. Cl. CPC B29C 45/14508; B29C 45/14344; B29C 45/14786; B29C 2045/14368; B29L 2031/3041

(57) ABSTRACT

A reinforced panel and a method of manufacture. The reinforced panel comprises a substrate and a polymeric material. The substrate comprises a first side and a second side. The polymeric material extends from at least the second side of the substrate. The substrate comprises a perimeter. The perimeter protrudes past the polymeric material.

### CROSS-REFERENCE TO RELATED APPLICATIONS

This application claims the benefit of U.S. provisional application Ser. No. 63/782,416, filed Apr. 2, 2025, the disclosure of which is hereby incorporated in its entirety by reference herein.

### TECHNICAL FIELD

The invention relates to a reinforced panel and a method of manufacture.

### BACKGROUND

U.S. Pat. No. 4,541,885 discloses a method of making a dielectrically embossed automotive seat cover assembly that includes forming a laminate of upper and lower foam layers, bonding a layer of covering material to the upper foam layer, and pressing an embossed pattern into the cover layer and upper foam layer while dielectrically heating the upper foam layer.

### SUMMARY

The invention relates to a method of making a reinforced panel. The method includes positioning a substrate on a first mold of a mold tool. The mold tool comprises a first mold and a second mold. The first mold comprises a first mold side and a first cavity. The first cavity extends from the first mold side. The second mold comprises a second mold side and a second cavity. The second cavity extends from the second mold side. The first cavity and the second cavity cooperate to define a mold cavity when the mold tool is closed. Next, the mold tool is closed. The first mold engages the second mold when the tool is closed. A perimeter of the substrate extends out of the mold cavity and is pinched between the first mold and the second mold when the mold tool is closed. Next, a polymeric material is injected into the mold cavity. The polymeric material is positioned against at least one side of the substrate. Next, the polymeric material is cured to form the reinforced panel.

Injecting the polymeric material into a mold cavity may comprise injecting the polymeric material through a through hole in the substrate. The through hole in the substrate may extend from a first side of the substrate to a second side of the substrate that is disposed opposite the first side.

Positioning the substrate on the first mold may comprise aligning the through hole in the substrate with an inlet port of the mold tool. The polymeric material is injected into the mold cavity via the inlet port. The through hole in the substrate may be larger than the inlet port. For instance, the through hole in the substrate may have a larger diameter or a larger area than the inlet port.

The polymeric material that is injected into the mold cavity may not contact the perimeter of the substrate that extends out of the mold cavity and is pinched between the first mold and the second mold.

The polymeric material that is injected into the mold cavity may extend along a first side of the substrate. The polymeric material that is injected into the mold cavity may extend into the through hole in the substrate. The polymeric material that is injected into the mold cavity may extend along the second side of the substrate.

The substrate may include one or more layers. The substrate may include a fabric layer.

The method may comprise assembling the substrate before positioning the substrate on the first mold. Assembling the substrate may comprise placing a first layer in contact with a second layer. Assembling the substrate may comprise bonding the first layer to the second layer. The first layer may be carpet. The first layer may be fabric. The first layer may be felt. The second layer may be a polymeric film. The second layer may extend from the first layer to the polymeric material.

The method may include positioning an exterior film on the second mold before closing the mold. At least a portion of the exterior film may contact the second mold. At least a portion of the exterior film may contact the second mold in the second cavity.

Injecting the polymeric material into the mold cavity may comprise injecting the polymeric material between the exterior film and the substrate. The polymeric material may extend from the substrate to the exterior film. The exterior film may not contact the substrate.

Positioning the exterior film on the second mold may comprise positioning the exterior film such that a perimeter of the exterior film extends out of the mold cavity. The perimeter of the exterior film that extends out of the mold cavity may be pinched between the first mold and the second mold when the mold tool is closed. The perimeter of the exterior film that extends out of the mold cavity may contact the perimeter of the substrate that extends out of the mold cavity. The perimeter of the exterior film that extends out of the mold cavity may contact the second layer of the substrate. The perimeter or of the exterior film may not contact the first layer of the substrate.

The invention also relates to a reinforced panel. The reinforced panel may comprise a substrate and a polyurethane material. The substrate may comprise a first side and a second side. The first side is opposite the second side. The polyurethane material extends from at least the second side of the substrate. The substrate comprises a perimeter. The perimeter protrudes past the polyurethane material.

The polyurethane material may extend from one or more sides of the substrate. In some configurations, the polyurethane material extends from the second side of the substrate but does not extend from the first side of the substrate. The polyurethane material may be disposed in a through hole in the substrate. The through hole may extend from the first side of the substrate to the second side of the substrate.

The reinforced panel may comprise an exterior film. The exterior film may contact the polyurethane material.

The reinforced panel may comprise a seat trim cover. The seat trim cover may contact the perimeter of the substrate. The seat trim cover may be secured to the perimeter of the substrate.

### BRIEF DESCRIPTION OF THE DRAWINGS

FIG. 1 is a perspective view of a generic example of a reinforced panel.

FIG. 2 is a section view of a mold tool and a first example of the reinforced panel.

FIG. 3 is a section view of a mold tool and a second example of the reinforced panel.

FIG. 4 is a section view of a mold tool and a third example of the reinforced panel.

FIG. 5 is a section view of a mold tool and a fourth example of the reinforced panel.

FIG. 6 is a section view of a mold tool and a fifth example of the reinforced panel.

FIG. 7 is a section view of a mold tool and a sixth example of the reinforced panel.

FIG. 8 is a section view of a mold tool and a seventh example of the reinforced panel.

FIG. 9 is a flowchart of a method of manufacturing the reinforced panel.

FIG. 10 is a side view of an example of a seat assembly that includes a trim cover that comprises a reinforced panel.

FIG. 11 is a perspective view of a reinforced panel configured as a floor mat.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising” when used in this specification, specify the presence of stated features, integers, steps, operations, elements, and/or components, but do not preclude the presence or addition of one or more other features, integers, steps, operations, elements, components, and/or groups thereof.

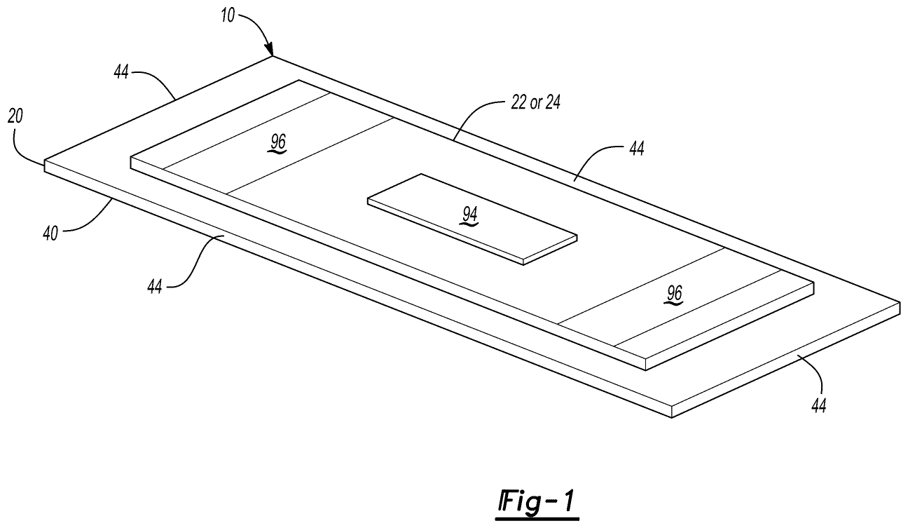

Referring to FIG. 1, an example of a reinforced panel 10 is shown. The reinforced panel 10 may be used in vehicular applications, such as automobiles, boats, trains, motorcycles, recreational vehicles (e.g., snowmobiles, all-terrain vehicles), and the like. In some configurations, the reinforced panel 10 may be part of a vehicle seat, such as a seat cover or portion thereof, a tray, a pocket, or the like. In some configurations, the reinforced panel 10 may be a cover that is not provided with a vehicle seat, such as a floor mat, cargo mat, a tonneau cover, interior trim panel such as a door panel or pillar cover, or the like.

As an overview, the reinforced panel 10 is provided with multiple layers and materials. These layers include a substrate 20, a polymer layer 22, and optionally an exterior film 24. The polymer layer 22 at least partially covers one or more sides of the substrate 20 and is overmolded onto the substrate 20 and the exterior film 24 if provided. Overmolding is an injection molding process that molds a polymeric material, such as a thermoset polymer like polyurethane, onto the substrate 20 and optionally the exterior film 24. Thus, the polymeric material forms the polymer layer 22 and is bonded to the substrate 20 (and to the exterior film 24 if provided) to produce a unitary one-piece panel. The substrate 20 provides reinforcement for the polymer layer 22.

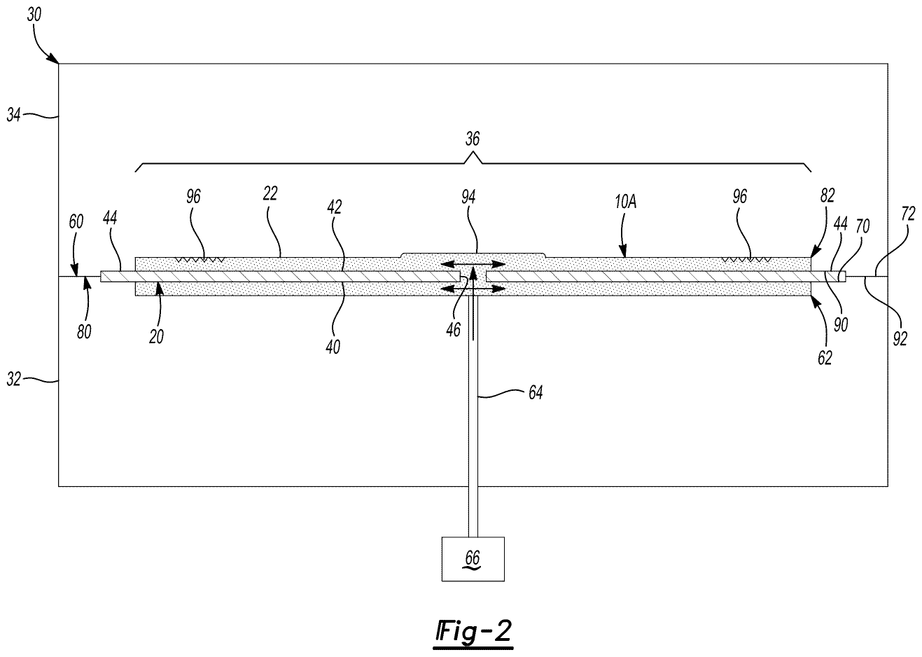

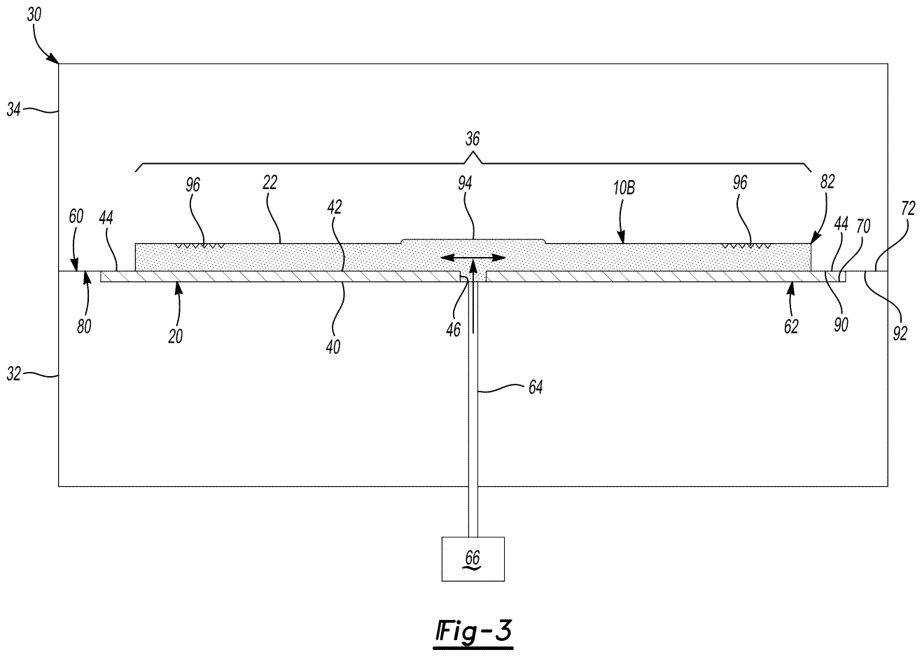

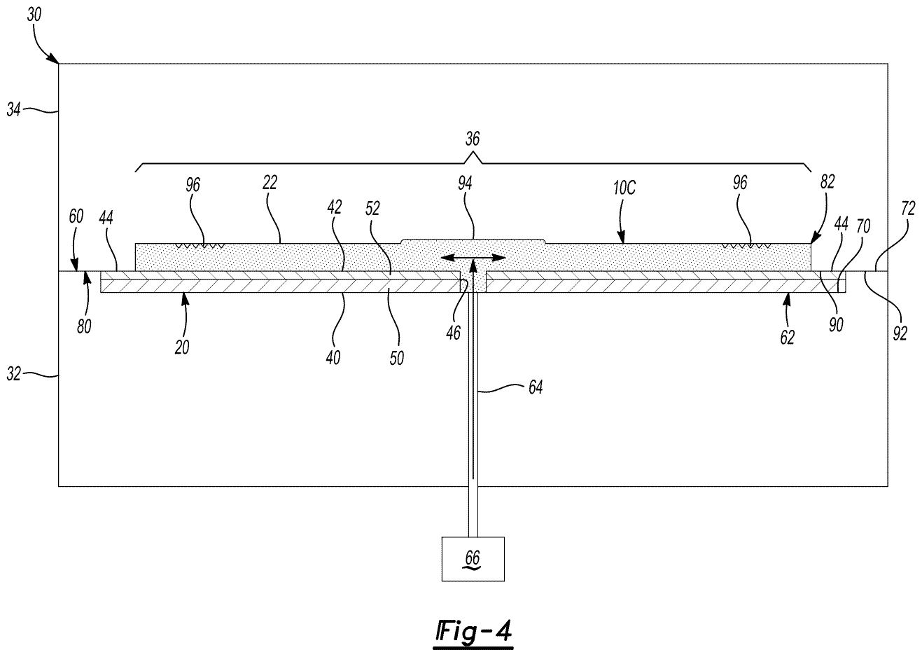

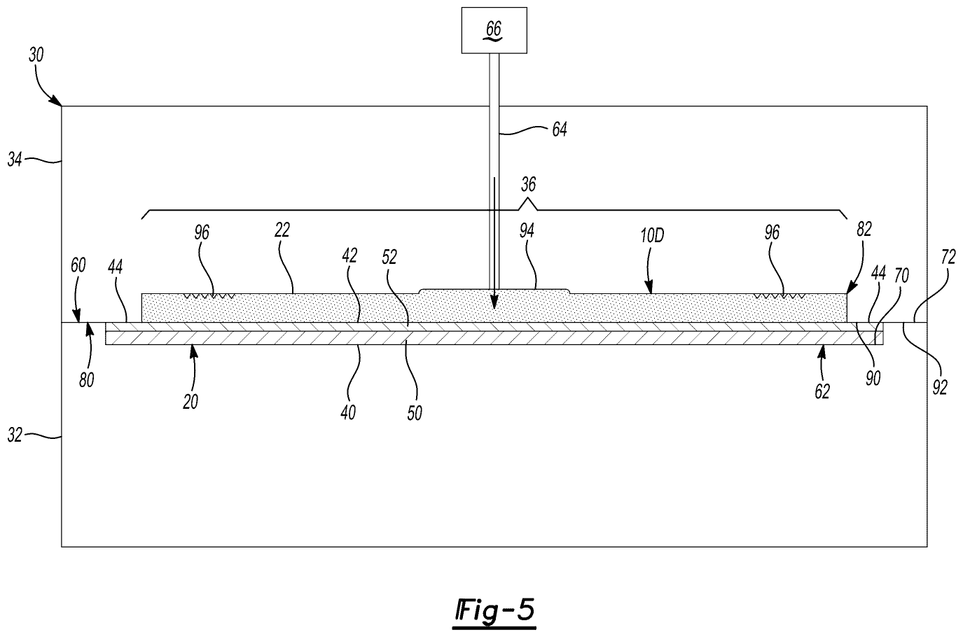

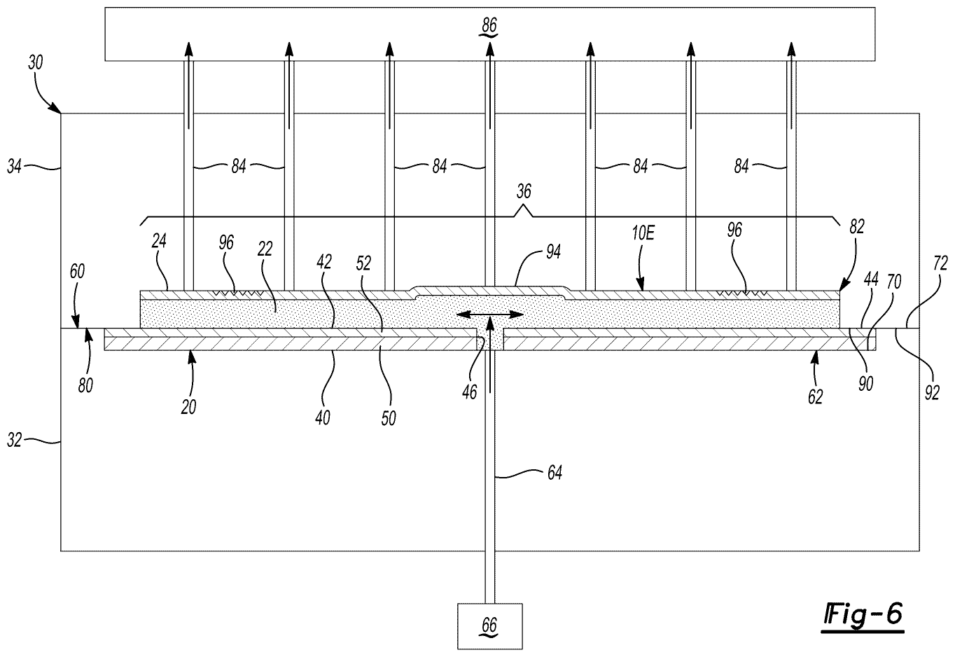

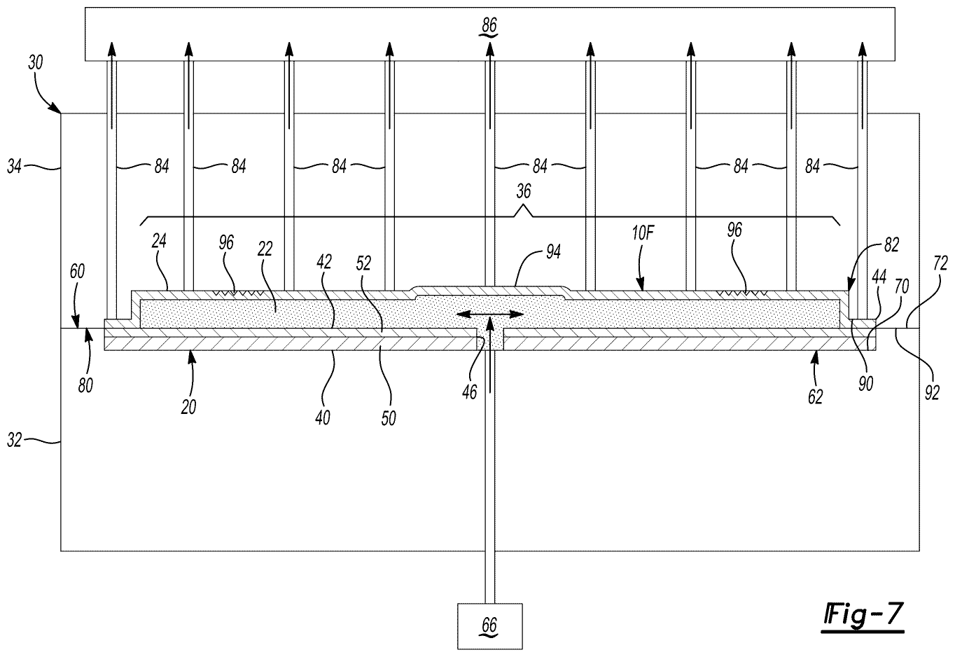

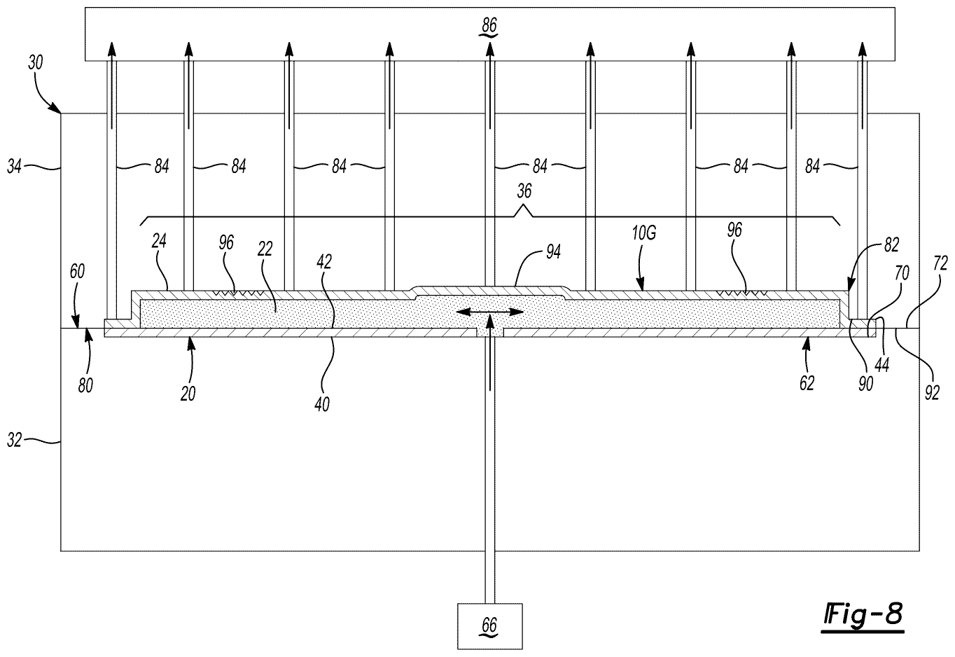

Examples of reinforced panels are shown in FIGS. 1-8, 10, and 11. FIG. 1 shows an example of a reinforced panel 10 that may be any of the reinforced panels associated with these figures. For convenience in reference, reference number 10 is used to generically designate the reinforced panel in the text below (and thus may be generically applicable to any of the reinforced panel configurations described herein). In FIGS. 2-8, a letter is appended to reference number 10 for convenience in referencing or designating a specific reinforced panel configuration. For instance, the reinforced panel is designated 10A in FIG. 2, 10B in FIG. 3, 10C in FIG. 4, 10D in FIG. 5, 10E in FIG. 6, 10F in FIG. 7, and 10G in FIG. 8.

FIGS. 2-8 show reinforced panels in conjunction with a mold tool 30 to better illustrate aspects of the manufacturing process. In some configurations, the mold tool 30 includes a first mold 32 and a second mold 34 that cooperate to form a mold cavity 36 when the mold tool 30 is closed as will be discussed in more detail below.

Referring primarily to FIG. 1, the substrate 20, which may also be referred to as a base or reinforcement layer, comprises material that reinforces the polymer layer 22. For instance, the substrate 20 may provide physical characteristics for durability, wear, stiffness, attachment, or combinations thereof. The substrate 20 may have any suitable configuration. In some configurations, the substrate 20 comprises a woven fabric (e.g., cloth, textile, etc.), a non-woven fabric (e.g., felt, compressed fiber mat, etc.), paper, carpet, film (e.g., polymeric film, barrier layer, etc.), or combinations thereof. As such, the substrate 20 may include a single layer or multiple layers. It is contemplated that a substrate 20 having multiple layers may be assembled into a unitary part prior to insertion into the mold tool 30.

Regardless of whether the substrate 20 includes a single layer or multiple layers, the substrate 20 comprises a first side 40, a second side 42, and a perimeter 44. In some configurations, the substrate 20 also comprises at least one through hole 46. The substrate 20 may comprise any suitable material or materials. For example, the substrate 20 may comprise a polymeric material (e.g., a thermoplastic polymer) or a non-polymeric material. Some examples of polymeric materials include ethylene polyester (e.g., polyethylene terephthalate (PET)), acrylic, polycarbonate, acrylonitrile butadiene styrene (ABS), and nylon. An example of a non-polymeric material is a metal or metal alloy like steel. The substrate material is compatible with material of the polymer layer 22.

The first side 40 faces toward a first mold 32 of the mold tool 30 when disposed in the mold tool 30, such as is shown in FIGS. 2-8. In FIGS. 2-8, the first side 40 is illustrated as being a flat substantially planar surface; however, it is to be understood that the first side 40 or a portion thereof may be nonplanar (e.g., bent, extend along an arc, include one or more protrusions, include one or more recesses, etc.). In some configurations, the first side 40 may contact the polymer layer 22. An example of such a configuration is shown in FIG. 2. In some configurations, the first side 40 faces away from the polymer layer 22 and does not contact the polymer layer 22. Examples of such configurations are shown in FIGS. 3-8. In such configurations, the first side 40 may be an exterior side of the reinforced panel, such as a back side or “B side” of the reinforced panel that is typically not visible when the reinforced panel is installed or in use. For instance, the first side 40 may be the back side of a floor mat, cargo mat, a tonneau cover, interior trim panel, seat trim cover, or the like that is not visible to a vehicle occupant or visible from outside the vehicle.

The second side 42 of the substrate 20 is disposed opposite the first side 40. The second side 42 of the substrate 20 may face toward a second mold 34 of the mold tool 30 when disposed in the mold tool 30, such as is shown in FIGS. 2-8. The second side 42 of the substrate 20 faces toward the polymer layer 22 or a portion thereof and may contact the polymer layer 22. For instance, the second side 42 may contact the polymer layer 22 and may be partially covered by the polymer layer 22.

As previously mentioned, the substrate 20 may comprise one or more layers. In FIGS. 2, 3 and 8, examples of a substrate 20 that comprises a single layer are shown. In these examples, the first side 40 is the bottom side of the substrate 20 from the perspective shown and the second side 42 is the opposing top side of the substrate 20 from the perspective shown.

In FIGS. 4-7, examples of a substrate 20 that has multiple layers are shown. In these examples, the substrate 20 is illustrated as comprising a first layer 50 and a second layer 52; however, it is contemplated that additional layers may be provided. In FIGS. 4-7, the first layer 50 forms the first side 40 of the substrate 20 and the second layer 52 forms the second side 42 of the substrate 20. In some configurations, the first layer 50 contacts the second layer 52. For instance, a side of the first layer 50 that is opposite the first side 40 may contact a side of the second layer 52 that is opposite the second side 42. In such configurations, the first layer 50 may be directly attached (e.g., bonded, fused, etc.) to the second layer 52 along at least a portion of the layer sides that are in contact. In some configurations, the first layer 50 is indirectly attached to the second layer 52, such as with an intervening adhesive. A substrate 20 that comprises multiple layers may be assembled before the substrate 20 is positioned on the mold tool 30.

The first layer 50 may be of any suitable type. For instance, the first layer 50 may be a woven fabric, non-woven fabric, paper, carpet, or film as previously discussed.

The second layer 52 extends from the first layer 50 to the polymer layer 22. The second layer 52 is primarily contemplated as being a film (e.g., polymeric film, barrier layer, etc.), such as a thermoplastic polyurethane film that separates the first layer 50 from the polymer layer 22. In some configurations, the thermoplastic polyurethane film is impermeable with respect to the polymer layer 22 and acts as a barrier that prevents the polymer layer 22 from entering or seeping into the first layer 50. For instance, the second layer 52 may prevent the polymeric material of the polymer layer 22 from penetrating into or through the first layer 50, which may help maintain a desired aesthetic appearance of the first layer 50, such as when the first layer 50 is carpet or a non-woven material. It is also contemplated that the second layer 52 may be air impermeable, water impermeable, or both. The second layer 52 may be coextensive with the first layer 50. In some configurations, it is contemplated that the positioning of the first layer 50 and the second layer 52 may be swapped.

The perimeter 44 of the substrate 20, which may also be called an extending portion, extends from or protrudes outwardly from the polymer layer 22. As such, the perimeter 44 is a portion of the substrate 20 that extends beyond or past the polymer layer 22. The perimeter 44 may protrude outwardly past the polymer layer 22 in multiple directions, such as is best shown in FIG. 1. In FIGS. 2-8, the perimeter 44 is depicted as protruding from opposing left and right sides of the polymer layer 22; however, it is contemplated that the perimeter 44 may protrude from additional sides of the polymer layer 22 that are not visible in these figures. The perimeter 44 extends out of the mold cavity 36 inside which the polymer layer 22 is disposed during manufacture and is pinched between the first mold 32 and the second mold 34 when the mold tool 30 is closed. As such, the first mold 32 and the second mold 34 may contact the perimeter 44 when the mold tool 30 is closed and the first mold 32 and second mold 34 may cooperate to exert force on the perimeter 44 to hold the substrate 20 in a desired position in the mold tool 30, which may prevent or limit movement of the substrate 20 when the material of the polymer layer 22 is injected into the mold cavity 36.

In the configuration shown in FIG. 2, the perimeter 44 is pinched between the first mold 32 and the second mold 34. The portion of the substrate 20 that is disposed in the mold cavity 36 is suspended between the first mold 32 and the second mold 34 such that a gap is provided between the substrate 20 and the first mold 32 and between the substrate 20 and the second mold 34. These gaps receive the material of the polymer layer 22 when the material of the polymer layer is injected into the mold cavity 36.

In the configurations shown in FIGS. 3-8, the perimeter 44 is pinched between the first mold 32 and the second mold 34. The portion of the substrate 20 that is disposed in the mold cavity 36 is disposed on the first mold 32 such that a gap is provided between the substrate 20 and the second mold 34 that receives the material of the polymer layer 22.

In some configurations, the substrate 20 defines one or more through holes 46. Examples of a substrate 20 that includes a through hole 46 are shown in FIGS. 2-4 and 6-8. The through hole 46 extends from the first side 40 of the substrate 20 to the second side 42 of the substrate 20. In some configurations, it is contemplated that the polymeric material of the polymer layer 22 may only pass through the substrate 20 via a through hole 46. In some configurations, it is contemplated that the polymeric material of the polymer layer 22 may partially enter or penetrate into the substrate 20 at locations other than the through hole 46.

The through hole 46 allows the material of the polymer layer 22 to be injected through the through hole 46 in the substrate 20, which in turn allows the polymer layer 22 to reach and extend along a side of the substrate 20 that faces away from the material injection location. For instance, in FIGS. 2-4 and 6-8, the material of the polymer layer 22 is injected through an inlet port in the first mold 32, passes through the through hole 46, and then extends or spreads along or across the second side 42 of the substrate 20. Such a configuration may allow the polymer layer material to be injected into the mold cavity 36 through one or more inlet ports that are provided in the first mold 32 instead of the second mold 34, which may simplify the design of the mold tool 30 as inlet ports can be omitted from the second mold 34.

Moreover, such a configuration may improve the appearance of the reinforced panel by hiding or concealing the location or an inlet port or location at which the polymer layer material is injected. For instance, a witness mark or other cosmetic defect may be visible on the reinforced panel that indicates where the polymer material is injected. Such a witness mark or cosmetic defect may be hidden by injecting material of the polymer layer 22 from the back side or “B side” of the reinforced panel and through the through hole 46 (e.g. a witness mark may be present on the B side of the reinforced panel but is not visible from the front side or “A side” (e.g., appearance side or side visible to the final user or customer) of the reinforced panel. In addition, such a configuration may allow a reinforced panel to be provided with a contiguous hole-free exterior film 24 in which the polymer layer material is not injected through the exterior film 24. As a result, the exterior film 24 may cover and conceal the polymer layer 22 along the visible side or “A side” of the reinforced panel.

The polymer layer 22 is overmolded onto the substrate 20 with an injection molding process. As such, the polymer layer material is injected into the mold cavity 36 in a molten state, shaped by one or more cavity surfaces of the mold tool 30 to a desired shape, and then allowed to cure to facilitate bonding to the substrate 20 and subsequent removal from the mold tool 30. The polymer layer 22 may be made of any suitable material or materials. For instance, the polymer layer 22 may be made of a urethane material such as polyurethane (aliphatic polyurethane, aromatic polyurethane, etc.). Polyurethane may be produced using a two-part chemical system, such as by a chemical reaction between polyols (e.g., alcohol with reactive hydroxyl groups) and diisocyanates in the presence of catalysts and additives. In some configurations, the polyurethane may be color-matched or yield the desired color of the resulting reinforced panel 10. In some configurations the polymer layer 22 may have a thickness of at least 0.8 mm but not greater than 10 mm.

The material of the polymer layer 22 may be selected to impart certain physical properties to the reinforced panel 10. For instance, the polymer layer 22 may be water resistant or waterproof. A water resistance or waterproof polymer layer 22 may allow the reinforced panel to better withstand exposure to liquids and contaminants (e.g., dirt, oil, particulates, etc.) and to be more easily cleaned (e.g., wiped or rinsed). In some configurations, the material of the polymer layer 22 may be elastomeric or flexible. Such a configuration may facilitate bending of the reinforced panel 10 to follow a desired contour, such as the contour of a supporting surface such as a vehicle floor or side of a vehicle seat or portion thereof. It is also contemplated that in some configurations, the polymer layer 22 may be rigid or substantially inflexible.

Referring to FIGS. 6-8, examples of reinforced panels that include an exterior film 24 are shown. The exterior film 24, if provided, may form an exterior surface of the reinforced panel. For instance, the exterior film 24 may form at least a portion of a visible A side of the reinforced panel. The exterior film 24 may provide a desired color or aesthetic appearance. For instance, the exterior film 24 may be opaque and provided with a desired color that is matched to customer specifications or meets customer specifications. Employing an exterior film 24 may provide more consistent color from panel to panel as compared to omitting the exterior film 24 and relying on the polymer layer 22. For example, it can be difficult to maintain sufficiently consistent coloring with a two-part polyurethane chemical system for various reasons, such as inconsistent mixing, inconsistent quantities, inconsistent chemical properties, contaminants, and the like.

The exterior film 24 may be made of any suitable material or materials, such as a polymeric material like thermoplastic polyurethane (TPU), acrylic, polycarbonate, or the like. Thus, the polymer layer 22 and exterior film 24 may be made of different materials. The material of the exterior film 24 is selected to be compatible with the material of the polymer layer 22. For instance, the material of the exterior film 24 may be selected to ensure that the exterior film 24 attaches or bonds to the polymer layer 22 during injection molding and maintains sufficient attachment or bonding in use. It is contemplated that the exterior film 24 may include one or more layers.

Referring to FIGS. 2-8, examples of a mold tool 30 and features of various reinforced panels will now be discussed in more detail. In these figures, the first mold 32 of the mold tool is depicted as the lower mold and the second mold 34 is depicted as the upper mold; however, it is contemplated that the mold designations can be reversed and the molds could be provided in different orientations.

The first mold 32 of the mold tool 30 comprises a first mold side 60, a first cavity 62, and one or more inlet ports 64.

The first mold side 60 faces toward the second mold 34. The first mold side 60 extends from and is disposed outside the first cavity 62. The first mold side 60 surrounds or encompasses the first cavity 62. In some configurations, the first mold side 60 includes a first portion 70 and a second portion 72.

The first portion 70 of the first mold side 60 extends outwardly from the first cavity 62 or an edge of the first cavity 62. The first portion 70 is configured to engage or contact the perimeter 44 of the substrate 20 that extends out of the mold cavity 36.

The second portion 72 of the first mold side 60 extends from the first portion 70. In some configurations, the second portion 72 extends from the first portion 70 to the exterior of the first mold 32. The second portion 72 engages or contacts the second mold 34 when the mold tool 30 is closed.

The first cavity 62 is a recess in the first mold 32 and extends from the first mold side 60. The first cavity 62 forms at least a portion of the mold cavity 36.

An inlet port 64, which may also be referred to as a fill passage, is fluidly connected to a dispenser 66 that injects the polymeric material of the polymer layer 22. The inlet port 64 is configured to deliver molten polymeric material to the mold cavity 36. The inlet port 64 has an inlet and an outlet. The inlet is fluidly connected to the dispenser 66 and is configured to receive molten polymeric material from the dispenser 66. The outlet is disposed opposite the inlet and provides the molten polymeric material to the first mold 32 and the mold cavity 36. Although not shown, the first mold 32 may include fluid passages through which a fluid, such as water, may be circulated to heat or cool the first mold 32.

The second mold 34 of the mold tool 30 comprises a second mold side 80 and a second cavity 82. In some configurations, such as is shown in FIG. 5, one or more inlet ports 64 are provided with the second mold 34. Optionally, the second mold 34 may include one or more vacuum passages 84, such as are shown in FIGS. 6-8. Although not shown, the second mold 34 may include fluid passages through which a fluid such as water may be circulated to heat or cool the second mold.

The second mold side 80 faces toward the first mold 32. For instance, the second mold side 80 faces toward and may be disposed opposite the first mold side 60. The second mold side 80 extends from and is disposed outside the second cavity 82. The second mold side 80 surrounds or encompasses the second cavity 82. In some configurations, the second mold side 80 includes a first portion 90 and a second portion 92.

The first portion 90 of the second mold side 80 extends outwardly from the second cavity 82 or an edge of the second cavity 82. The first portion 90 is configured to engage or contact the perimeter 44 of the substrate 20 that extends out of the mold cavity 36.

The second portion 92 of the second mold side 80 extends from the first portion 90. In some configurations, the second portion 92 extends from the first portion 90 to the exterior of the second mold 34. The second portion 92 engages or contacts the second portion 72 of the first mold 32 when the mold tool 30 is closed.

The second cavity 82 is a recess in the second mold 34 and extends from the second mold side 80. The second cavity 82 forms a portion of the mold cavity 36. The first cavity 62 and the second cavity 82 cooperate to define a mold cavity 36 when the mold tool 30 is closed. The mold cavity 36 receives a portion of the substrate 20 and receives the polymer layer 22. Depending on the configuration of the mold tool 30, the polymer layer 22 is received in at least one of the first cavity 62 and the second cavity 82.

In some configurations, the first mold 32, the second mold 34, or both may be configured to form a graphical feature 94 on the exterior of the reinforced panel 10, such as a logo, graphic, word, letter, character, or symbol, a textured surface 96, or both. A graphical feature 94 or textured surface 96 may be embossed in a portion of the reinforced panel 10, such as the polymer layer 22 and exterior film 24 if provided. A textured surface 96 may be a grain pattern that provides an appearance that resembles animal skin or leather grain, a “pebbled” pattern, a rough or sandblasted texture, or the like.

Referring to FIGS. 6-8, one or more vacuum passages 84 may be provided with a mold, such as the second mold 34. A vacuum passage 84 may be fluidly connected to a vacuum pump. The vacuum pump may be fluidly connected to a vacuum passage 84 directly or via a manifold 86. The vacuum pump may create suction or reduced pressure that may hold the exterior film 24 against the second mold 34. In some configurations, a vacuum passage 84 may extend from a surface of the second mold 34 that at least partially defines the second cavity 82. In some configurations, a vacuum passage 84 may also extend from first portion 90 of the second mold side 80.

Referring to FIG. 9, a flowchart of an example of a method of manufacturing the reinforced panel 10 is shown. The method will be described in conjunction with FIGS. 2-8.

At block 100, the mold tool 30 is opened. The mold tool 30 is opened by at least partially separating the first mold 32 and the second mold 34. For instance, the mold tool 30 may located in a press that is configured to actuate the first mold 32, the second mold 34, or both. In some configurations, the second mold 34 is moved upward or linearly away from the second mold 34 to separate the second mold 34 from the first mold 32 and open the mold tool 30. In some configurations, the second mold 34 is pivoted away from the first mold 32 to open the mold tool 30. Opening the mold tool 30 allows material to be placed inside the mold tool 30, such as in the mold cavity 36.

At block 102, one or more material layers are positioned on the mold tool 30.

Positioning one or more material layers on the mold tool 30 includes positioning the substrate 20 on a mold, such as the first mold 32. Positioning the substrate 20 on the first mold 32 may comprise aligning the through hole 46 in the substrate 20 with an inlet port 64. The through hole 46 of the substrate 20 may be larger than the inlet port 64. For instance, the through hole 46 in the substrate 20 may have a larger diameter or larger area than the inlet port 64 or outlet of the inlet port 64. Such a configuration may prevent the substrate 20 from blocking or overlapping the inlet port 64 and thus prevent the substrate 20 from blocking or impeding injection of polymeric material that forms the polymer layer 22 into the mold cavity 36. In addition, providing a through hole 46 in the substrate 20 that is larger than the outlet of the inlet port 64 may increase the positioning tolerance for the substrate 20 on the mold tool 30. As such, the substrate 20 may be positioned on the first mold 32 less precisely or with more variance without blocking or overlapping the outlet of the inlet port 64, which may allow the substrate 20 to be positioned more quickly and help reduce cycle time. In some configurations, the substrate 20 extends into the first cavity 62 and the second cavity 82, such as is shown in FIG. 2. In some configurations, the substrate 20 is disposed in the first cavity 62 but not the second cavity 82 as shown in FIGS. 3-8.

As shown in FIGS. 6-8, positioning one or more material layers may comprise positioning exterior film 24 on a mold, such as the second mold 34. At least a portion of the exterior film 24 may contact the second mold 34 and extend into the second cavity 82. For instance, the exterior film 24 may extend across a bottom surface of the second cavity 82 as shown in FIGS. 6-8. As shown in FIGS. 7 and 8, the exterior film 24 may optionally extend out of the second cavity 82 and extend along the second mold side 80, such as along the first portion 90 of the second mold side 80. The exterior film 24 may be held in position with suction or vacuum force exerted on the exterior film 24 via one or more vacuum passages 84.

At block 104, the mold tool 30 is closed. The mold tool 30 is closed by moving the first mold 32, the second mold 34, or both to engage the first mold 32 and the second mold 34. In some configurations, the second mold 34 is moved downward or linearly toward the second mold 34 to engage the second mold 34 against the first mold 32 and close the mold tool 30. In some configurations, the second mold 34 is pivoted toward the first mold 32 to close the mold tool 30. Closing the mold tool 30 pinches the perimeter 44 of the substrate 20 between the first mold 32 and the second mold 34 and forms and encloses the mold cavity 36 to trap the polymeric material that will be injected into the mold cavity 36.

In some configurations that include the exterior film 24, the exterior film 24 is not pinched between the first mold 32 and the second mold 34 when the mold tool 30 is closed. An example of such a configuration is shown in FIG. 6.

In some configurations that include the exterior film 24, the exterior film 24 is pinched between the first mold 32 and the second mold 34 to help hold the exterior film 24 in place. Examples of such configurations are shown in FIGS. 7 and 8. In FIG. 7, a perimeter of the exterior film 24 is pinched against and contacts the second layer 52 of the substrate 20. In FIG. 8, the perimeter of the exterior film 24 is pinched against and contacts the first layer 50 of the substrate 20.

At block 106, polymeric material is injected to form the polymer layer 22. In FIGS. 2-8, polymeric material is not shown in the inlet port 64 for clarity to more clearly depict the polymer layer 22. Injecting polymeric material into the mold cavity 36 forces the polymeric material against one or more sides of the substrate 20. Flow of polymeric material is represented by the arrowed lines in FIGS. 2-8. For instance, polymeric material that is injected into the mold cavity 36 may extend along the first side 40 of the substrate 20, the second side 42 of the substrate 20, or both.

In FIG. 2, polymeric material flows along the first side 40 of the substrate 20, through the through hole 46, and along the second side 42 of the substrate 20. As a result, the polymer layer 22 extends from the first side 40 of the substrate 20 to the first mold 32, from the second side 42 of the substrate 20 the second mold 34, and fills the through hole 46.

In FIGS. 3, 4, and 6-8, polymeric material flows through the through hole 46 and along the second side 42 of the substrate 20 but not along the first side 40 of the substrate 20. In FIGS. 3 and 4, the resulting polymer layer 22 extends from the second side 42 of the substrate 20 to the second mold 34 and fills the through hole 46. In FIG. 6, the resulting polymer layer 22 extends from the second side 42 of the substrate 20 the exterior film 24, extends to the second mold 34 between the exterior film 24 and the substrate 20 where the exterior film 24 is not present, and fills the through hole 46. In FIGS. 7 and 8, the resulting polymer layer 22 extends from the second side 42 of the substrate 20 the exterior film 24 but does not extend to the second mold 34 and fills the through hole 46.

In FIG. 5, polymeric material flows into the second cavity 82 and along the second side 42 of the substrate 20 but not along the first side 40 of the substrate 20. The resulting polymer layer 22 extends from the second side 42 of the substrate 20 the second mold 34.

It is contemplated that the polymeric material may or may not penetrate or enter the substrate 20 at locations other than the through hole 46. In some configurations, polymeric material may enter openings or indentations in the substrate 20 that extend from one side of the substrate 20 but not through the substrate 20. In some configurations, polymeric material may enter openings in the substrate 20 that are through holes in the substrate 20.

Polymeric material that is injected into the mold cavity 36 does not contact the perimeter 44 of the substrate 20 that extends out of the mold cavity 36 and is pinched between the first mold 32 and the second mold 34. It is noted that the mold tool 30 can include vents that allow air to be pushed out of the mold cavity 36 when the polymeric material is being injected.

At block 108, the polymeric material of the polymer layer 22 is cured. The polymeric material cures as it cools. Curing hardens and solidifies the polymer layer 22. The polymeric material may be cooled for a predetermined period of time or to a predetermined temperature to cure the polymer layer 22. Cooling time may be reduced by circulating fluid through the mold tool 30 to transfer heat from the mold tool 30. The resulting assembly comprising the substrate 20, polymer layer 22, and optionally the exterior film 24 is referred to as a reinforced panel 10 once the polymeric material is cured.

At block 110, the mold tool 30 is opened. The mold tool 30 may be opened as previously described.

At block 112, the reinforced panel 10 is removed from the mold tool 30. The reinforced panel 10 may be removed manually or with automated equipment, such as ejector pins in the mold tool 30, a robotic manipulator, or combinations thereof.

At block 114, finishing operations are performed.

In some configurations, finishing operations include trimming the reinforced panel 10 to a final shape. For instance, the perimeter 44 of the reinforced panel 10 or a portion thereof may be trimmed or removed using a cutting tool, such as a blade, punch, die, or the like.

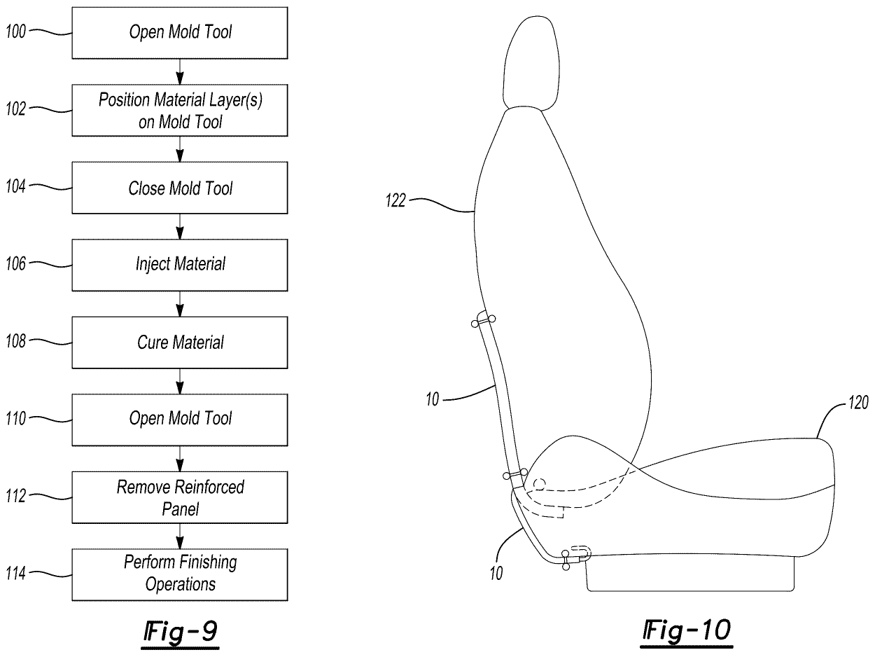

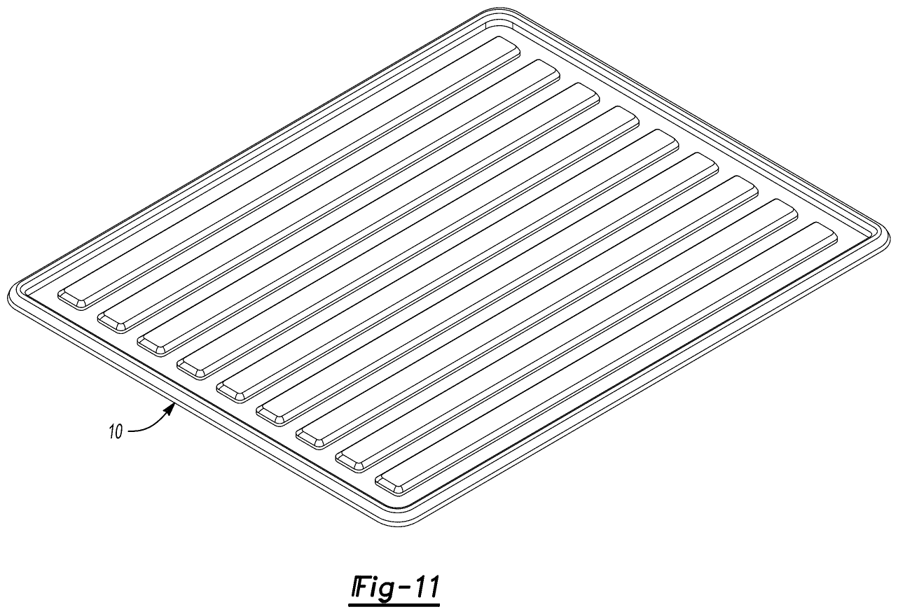

In some configurations, finishing operations include attaching the reinforced panel 10 to another component. For instance, the reinforced panel 10 may be attached to a trim cover of a vehicle seat as shown in FIG. 10. In FIG. 10, the vehicle seat includes a seat bottom and a seat back. The seat back may be pivotable with respect to the seat bottom. The seat bottom may have a seat bottom trim cover 120. The seat back may have a seat back trim cover 122. A reinforced panel 10 may be provided with the seat bottom trim cover 120, the seat back trim cover 122, or both. For instance, a reinforced panel may be attached to one or more panels of a trim cover. In some configurations, the reinforced panel 10 may be attached to a trim cover at or along the perimeter 44 of the reinforced panel. The reinforced panel 10 may be attached in any suitable manner, such as with an adhesive, stitching, zipper, mechanical fastener like a clip or rivet, or the like. It is also contemplated that a portion of the perimeter 44 such as a free end portion of the perimeter that does not contact the trim cover may be secured to a frame of the seat, such as with a fastener like a hook, clip, or the like.

Referring to FIG. 11, a reinforced panel that is configured as a floor mat is shown. In such a configuration, the perimeter 44 may be removed as a finishing operation.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method comprising:
positioning a substrate on a first mold of a mold tool, the mold tool comprising:
the first mold, the first mold comprising a first mold side and a first cavity extending from the first mold side; and
a second mold, the second mold comprising a second mold side and a second cavity extending from the second mold side, wherein the first cavity and the second cavity cooperate to define a mold cavity when the mold tool is closed;
closing the mold tool by engaging the first mold and the second mold, wherein a perimeter of the substrate extends out of the mold cavity and is pinched between the first mold and the second mold when the mold tool is closed;
injecting a polymeric material into the mold cavity and against at least one side of the substrate; and
curing the polymeric material to form a reinforced panel.

2. The method of claim 1 wherein injecting the polymeric material into the mold cavity comprises injecting the polymeric material through a through hole in the substrate, the through hole extending from a first side of the substrate to a second side of the substrate disposed opposite the first side.

3. The method of claim 2 wherein positioning the substrate on the first mold comprises aligning the through hole in the substrate with an inlet port of the mold tool through which the polymeric material is injected into the mold cavity.

4. The method of claim 3 wherein the through hole in the substrate is larger than the inlet port.

5. The method of claim 2 wherein the polymeric material that is injected into the mold cavity does not contact the perimeter of the substrate that extends out of the mold cavity and is pinched between the first mold and the second mold when the mold tool is closed.

6. The method of claim 2 wherein the polymeric material that is injected into the mold cavity extends along the first side of the substrate, extends into the through hole in the substrate, and extends along the second side of the substrate.

7. The method of claim 2 wherein the polymeric material that is injected into the mold cavity extends through the through hole in the substrate and extends along the second side of the substrate but does not extend along the first side of the substrate.

8. The method of claim 1 wherein the substrate is a fabric layer.

9. The method of claim 1 further comprising assembling the substrate before positioning the substrate on the first mold, wherein assembling the substrate comprises placing a first layer in contact with a second layer and bonding the first layer to the second layer.

10. The method of claim 9 wherein the first layer is one of a carpet, fabric, or felt and the second layer is a polymeric film that extends from the first layer to the polymeric material.

11. The method of claim 1 further comprising positioning an exterior film on the second mold before closing the mold, wherein at least a portion of the exterior film contacts the second mold in the second cavity.

12. The method of claim 11 wherein injecting the polymeric material into the mold cavity comprises injecting the polymeric material between the exterior film and the substrate such that the polymeric material extends from the substrate to the exterior film and the exterior film does not contact the substrate.

13. The method of claim 11 wherein positioning the exterior film on the second mold further comprises positioning the exterior film such that a perimeter of the exterior film extends out of the mold cavity and is pinched between the first mold and the second mold when the mold tool is closed.

14. The method of claim 13 wherein the perimeter of the exterior film that extends out of the mold cavity contacts the perimeter of the substrate that extends out of the mold cavity.

15. The method of claim 14 further comprising assembling the substrate before positioning the substrate on the first mold, wherein assembling the substrate comprises placing a first layer in contact with a second layer and bonding the first layer to the second layer, and wherein the perimeter of the exterior film that extends out of the mold cavity contacts the second layer of the substrate and does not contact the first layer of the substrate.

16. A reinforced panel comprising:
a substrate comprising a first side and a second side opposite the first side; and
a polyurethane material extending from at least the second side of the substrate, wherein the substrate comprises a perimeter that protrudes past the polyurethane material.

17. The reinforced panel of claim 16 wherein the polyurethane material extends from the second side of the substrate but not the first side of the substrate.

18. The reinforced panel of claim 16 wherein the polyurethane material extends from the second side of the substrate and is disposed in a through hole in the substrate that extends from the first side to the second side.

19. The reinforced panel of claim 16 further comprising an exterior film that contacts the polyurethane material.

20. The reinforced panel of claim 16 further comprising a seat trim cover that contacts and is secured to the perimeter of the substrate.
